(19) United States
(12) Patent Application Publication
(10) Pub. No.: US 2011/0289447 A1
(43) Pub. Date: Nov. 24, 2011

(54) INFORMATION PROCESSING APPARATUS AND CONTROL METHOD

(75) Inventors: Takesi Kawaguti, Shizuoka (JP); Masanori Sambe, Shizuoka (JP)

(73) Assignee: TOSHIBA TEC KABUSHIKI KAISHA, Tokyo (JP)

(21) Appl. No.: 13/109,076

(22) Filed: May 17, 2011

(30) Foreign Application Priority Data
May 24, 2010 (JP) 2010-118465

(51) Int. Cl. G06F 3/048

(52) U.S. Cl. 715/780

(57) ABSTRACT

According to one embodiment, an information processing apparatus includes: an operation unit configured to receive operation by a user; a display unit configured to display an editing screen including plural cells included in table data and a cursor indicating a place where editing corresponding to the operation is executed; and a cursor moving unit configured to move, if cursor moving operation for moving the cursor among the cells is received, the cursor to an editable cell on the basis of setting information indicating possibility of editing set in advance for each element of at least one of a row, a column, and a cell of a table including the plural cells.

### CROSS-REFERENCE TO RELATED APPLICATION

This application is based upon and claims the benefit of priority from the prior Japanese Patent Application No. 2010-118465, filed on May 24, 2010; the entire contents of which are incorporated herein by reference.

### FIELD

Embodiments described herein relate generally to an information processing apparatus and a control method.

### BACKGROUND

In the past, some information processing apparatus such as a PC (Personal Computer) receives an operation input of a user and performs editing of cells included in table data. The editing of the cells included in the table data is performed by moving, through key operation or the like, a cursor indicating a place where editing operation is executed on a cell to be edited. During the editing of the cells included in the table data, operability of the movement of the cursor is improved by moving the cursor among the cells in which data is stored.

However, in the editing of the cells included in the table data, when the movement of the cursor is performed among the cells in which the data is stored, in some cases, the cursor is moved to an uneditable cell subjected to read-only setting or the like. If the cursor is moved to the uneditable cell, the operability is deteriorated because it is necessary to perform again operation for moving the cursor to an editable cell. In some cases, the user's sense of use is deteriorated.

### DESCRIPTION OF THE DRAWINGS

FIG. 1 is a block diagram of an example of an information processing apparatus according to an embodiment;

FIG. 2 is a diagram of an example of table data;

FIG. 3 is a diagram of an example of uneditability setting information;

FIG. 4 is a flowchart for explaining an example of the operation of the information processing apparatus according to the embodiment; and

FIG. 5 is a diagram of an example of the movement of a cursor.

### DETAILED DESCRIPTION

In general, according to one embodiment, an information processing apparatus includes: an operation unit configured to receive operation by a user; a display unit configured to display an editing screen including plural cells included in table data and a cursor indicating a place where editing corresponding to the operation is executed; and a cursor moving unit configured to move, if cursor moving operation for moving the cursor among the cells is received, the cursor to an editable cell on the basis of setting information indicating possibility of editing set in advance for each element of at least one of a row, a column, and a cell of a table including the plural cells.

In general, according to another embodiment, a control method for an information processing apparatus including an operation unit configured to receive operation by a user and a display unit includes: displaying an editing screen including plural cells included in table data and a cursor indicating a place where editing corresponding to the operation is executed; and moving, if cursor moving operation for moving the cursor among the cells is received, the cursor to an editable cell on the basis of setting information indicating possibility of editing set in advance for each element of at least one of a row, a column, and a cell of a table including the plural cells.

An information processing apparatus and a control method according to an embodiment are explained below with reference to the accompanying drawings. An information processing apparatus 1 may be an information apparatus such as a PC (Personal Computer). In an example explained in this embodiment, in a store such as a restaurant or a supermarket, the information processing apparatus 1 is used as a store server, a POS terminal, and the like that perform editing of table data such as customer master data for managing information concerning customers and commodity master data for managing information concerning commodities for sale.

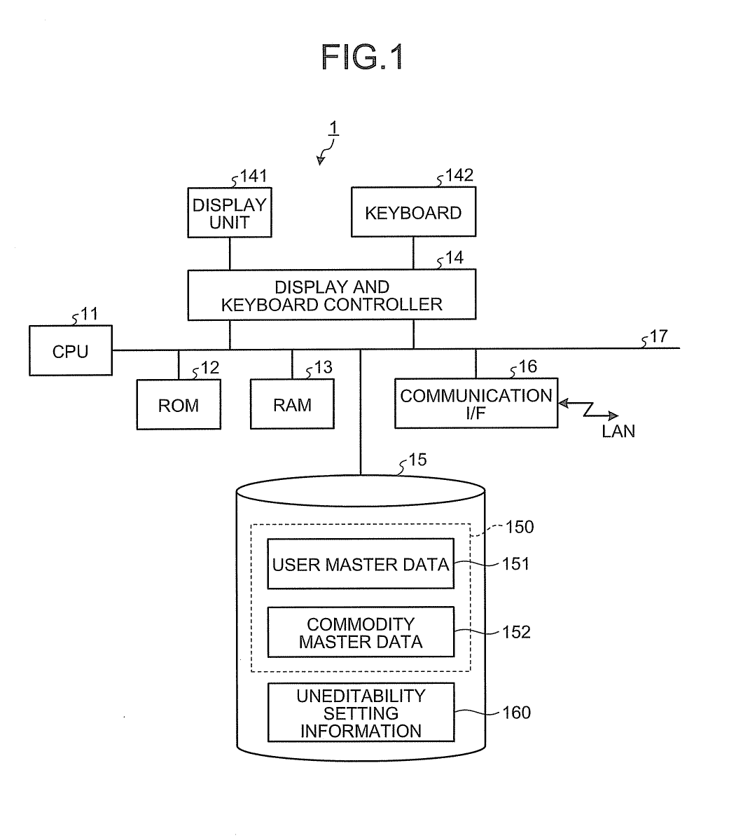

FIG. 1 is a block diagram of an example of the information processing apparatus 1 according to this embodiment. As shown in FIG. 1, the information processing apparatus 1 includes a CPU (Central Processing Unit) 11, a ROM (Read-only Memory) 12, a RAM (Random Access Memory) 13, a display and keyboard controller 14, a storing unit 15, a communication I/F 16, a bus 17, a display unit 141, and a keyboard 142.

The CPU 11 is connected to the ROM 12, the RAM 13, the display and keyboard controller 14, the storing unit 15, and the communication I/F 16 via the bus 17. The CPU 11 centrally controls the operation of the information processing apparatus 1. Specifically, the CPU 11 expands computer programs stored in the storing unit 15, the ROM 12, and the like in a work area of the RAM 13 and sequentially executes the computer programs to perform control of the units. In the information processing apparatus 1, the CPU 11 sequentially executes a job application program for performing editing of table data, whereby editing of the table data corresponding to an operation input from a user is performed. The ROM 12 stores the computer programs and various kinds of setting information. The RAM 13 provides the work area for the CPU 11 to execute the computer programs.

The display and keyboard controller 14 controls the display unit 141 and the keyboard 142 under the control by the CPU 11. Specifically, the display and keyboard controller 14 performs display corresponding to display data received from the CPU 11 on the display unit 141. The display and keyboard controller 14 outputs an input signal received from the keyboard 142 or a touch panel (not shown) to the CPU 11.

The display unit 141 is an LCD (Liquid Crystal Display) or the like. The display unit 141 performs screen display by the display and keyboard controller 14. For example, during editing of cells included in table data, the display unit 141 displays, under the control by the CPU 11, an editing screen including plural cells included in the table data and a cursor indicating a place where editing corresponding to operation is executed.

The keyboard 142 serving as an operation unit receives operation by the user. Specifically, the keyboard 142 includes character keys, number keys, cursor keys (arrow keys) for movement of the cursor, a Tab key, and other various function keys. The keyboard 142 outputs an input signal corresponding to key operation by the user to the display and keyboard controller 14. The display unit 141 includes the touch panel on a screen. In the information processing apparatus 1, operation by the user may be received by the touch panel.

In the information processing apparatus 1, during the editing of the cells included in the table data, the movement of the cursor among the cells and input to a cursor position are performed by the operation of the keyboard 142 and the touch panel. Specifically, the movement of the cursor among the cells is performed according to pressing operation of the cursor keys and the Tab key of the keyboard 142 or touch operation of button images corresponding to the cursor keys displayed on the touch panel. For example, according to the operation of the cursor keys in the left and right directions, the movement of the cursor among the cells in the lateral direction is performed. According to the operation of the cursor keys in the up and down directions, the movement of the cursor among the cells in the longitudinal direction is performed. According to the operation of the Tab key, the movement of the cursor to a cell set in advance (e.g., the movement to a cell on the right of a cell on which the cursor is currently present) is performed. The input to a cursor position is performed according to pressing of the character keys and the number keys. The movement of the cursor among the cells may be performed using the character keys and the number keys instead of the cursor keys.

The storing unit 15 is, for example, a HDD (Hard Disk Drive). The storing unit 15 stores table data 150, uneditability setting information 160, various computer programs, and the like. The communication I/F 16 performs, under the control by the CPU 11, data communication with other apparatuses via a LAN (Local Area Network) or the like.

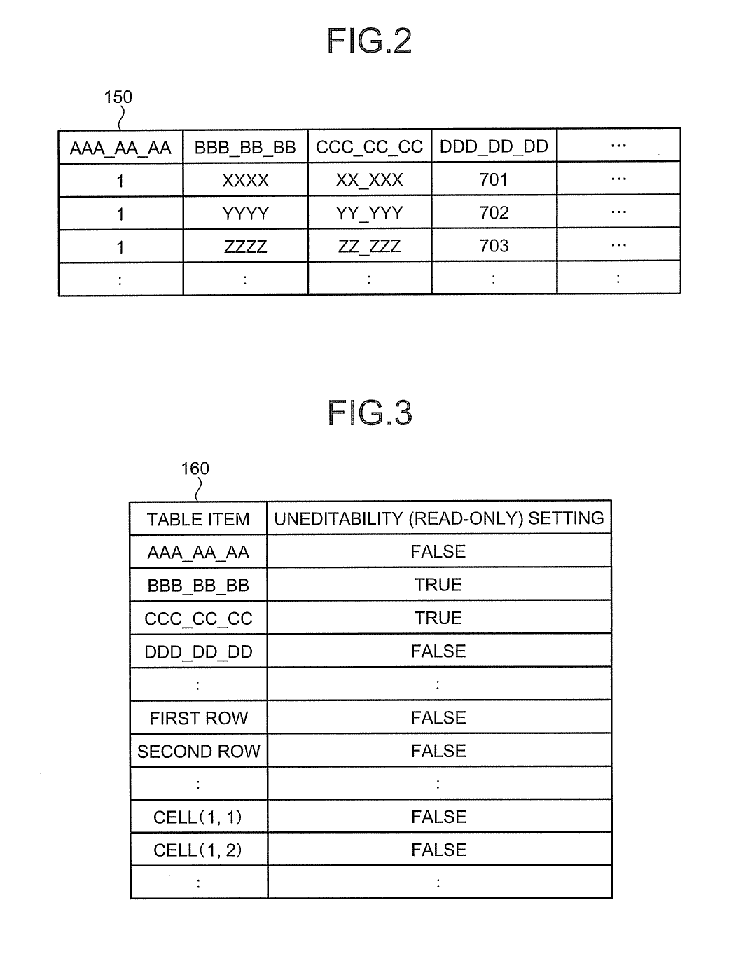

The table data 150 is data of a table format including plural cells. FIG. 2 is a diagram of an example of the table data 150. As shown in FIG. 2, the table data 150 includes, as items of columns, “AAA_AA_AA”, “BBB_BB_BB”, “CCC_CC_CC”, and “DDD_DD_DD”. Concerning a cell in a first row of the table data 150, values such as “1”, “XXXX”, “XX_XXX”, and “701” are set in order from “AAA_AA_AA” to “DDD_DD_DD”. In the following explanation, a cell in an nth row and an mth column in table data is referred to as cell (n, m). For example, in the example shown in FIG. 2, a value “YYYY” is set in a cell (2, 2).

The table data 150 in this embodiment includes user master data 151 for managing information concerning customers and commodity master data 152 for managing information concerning commodities for sale in a store. For example, the user master data 151 is table data in which, with a customer code uniquely allocated to each customer set as a record in one row, information such as an address, a name, and a date of birth of the customer is stored. The commodity master data 152 is table data in which, with a commodity code uniquely allocated to each commodity set as a record in one row, information such as a unit price and a commodity classification of the commodity is stored.

In the uneditability setting information 160, for each of elements of a table (rows, columns, and cells included in the table) related to the plural cells included in the table data 150, it is set whether data stored in the elements are editable or uneditable (read-only). Therefore, in the uneditability setting information 160, the setting concerning whether data is editable or uneditable is performed not only for each of the cells but also for each of the rows or the columns. The elements of the table set in the uneditability setting information 160 may be at least any one of the rows, the columns, and the cells. The uneditability setting information 160 only has to be associated with the table data 150 as property data of the table data 150 and may be file data separate from the table data 150. For example, the uneditability setting information 160 may be a setting file associated with each of the user master data 151 and the commodity master data 152 by a file name or the like.

FIG. 3 is a diagram of an example of the uneditability setting information 160. As shown in FIG. 3, in the uneditability setting information 160, uneditability (read-only) setting is performed using values such as “FALSE” and “TRUE” for each of columns such as “AAA_AA_AA” and “BBB_BB_BB”, for each of rows such as a first row and a second row, and for each of cells such as a cell (1, 1) and a cell (1, 2). In the example shown in FIG. 3, the columns of “BBB_BB_BB” and “CCC_CC_CC” in the table data are set as “TRUE” and uneditability is set in the column. The other elements (e.g., the column “AAA_AA_AA” and the first row and the second row) are set as “FALSE” and editability is set in the elements.

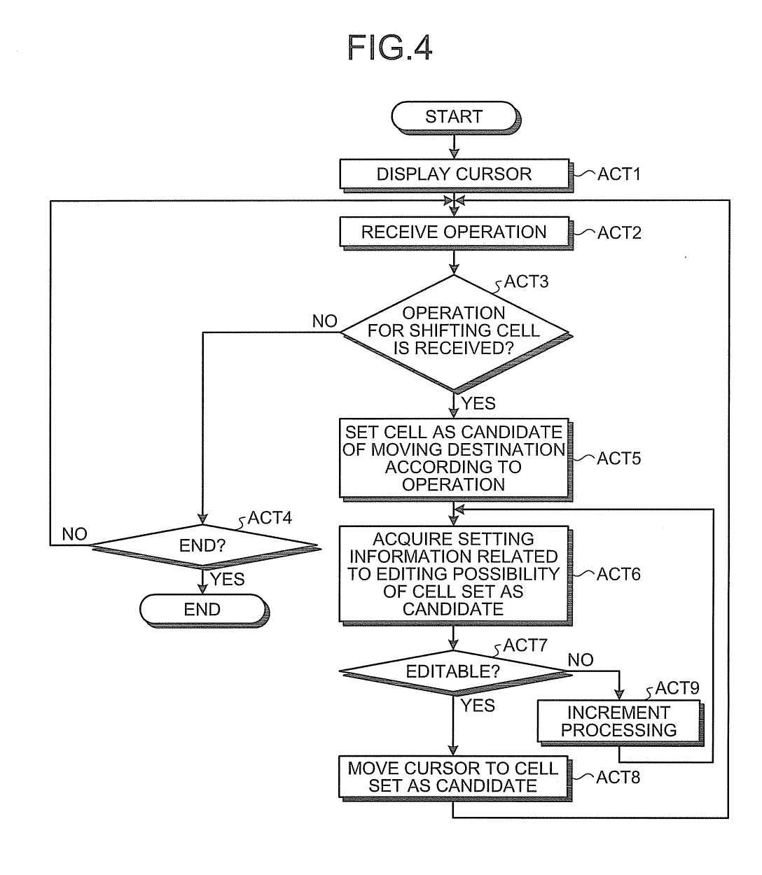

An example of the operation of the information processing apparatus 1 realized by being controlled by the CPU 11 according to a computer program stored in the ROM 12 or the like is explained with reference to FIG. 4. More specifically, a series of operation related to editing of the table data 150 corresponding to an operation input from the user is explained. FIG. 4 is a flowchart for explaining an example of the operation of the information processing apparatus 1 according to this embodiment.

As shown in FIG. 4, when processing is started, the CPU 11 reads out the table data 150 such as the user master data 151 and the commodity master data 152 from the storing unit 15 and displays the table data 150 on the display unit 141. Subsequently, the CPU 11 displays a cursor in a predetermined cell from which editing is started (Act 1). The predetermined cell from which the editing is started may be, for example, the cell (1, 1) at the top of the table. If an editing history is recorded, on the basis of the editing history, a cell on which the cursor is present at the end of the last editing may be set as the cell from which the editing is started.

Subsequently, the CPU 11 receives operation by the user on the keyboard 142 or the touch panel (Act 2). The CPU 11 determines whether the operation received in Act 2 is operation for shifting an editing target cell on which the cursor is displayed (Act 3). As explained above, as the operation for shifting the editing target cell, there are, for example, the pressing operation of the cursor keys and the Tab key of the keyboard 142 and the touch operation of the button images corresponding to the cursor keys displayed on the touch panel.

If the operation received in Act 2 is not the operation for shifting the editing target cell (No in Act 3), for example, if the operation is input operation to a cursor position by, for example, pressing of the character keys and the number keys, editing of a cell corresponding to the input is performed. The CPU 11 determines whether the processing for the editing of the table data 150 is ended according to an operation input by the user (Act 4). If the processing is not ended (No in Act 4), the CPU 11 returns the processing to Act 2 and continues the editing of the table data 150.

If the operation received in Act 3 is operation for shifting the editing target cell (Yes in Act 3), the CPU 11 sets a cell as a candidate of a moving destination according to the operation (Act 5). Specifically, if operation for shifting a cell is the depressing operation of the cursor key, a cell adjacent to the editing target cell at the present point in a direction designated by the cursor key is set as the candidate of the moving destination. If the operation for shifting a cell is the pressing operation of the Tab key, a cell set in advance (e.g., a cell on the right of the editing target cell at the present point) is set as the candidate of the moving destination.

The CPU 11 reads out the uneditability setting information 160 and acquires setting information related to possibility of editing of the cell set as the candidate of the moving destination (Act 6). For example, if the cell (1, 1) is the editing target, it is assumed that shift to the cell (1, 2) in the right direction with respect to the cell (1, 1) is instructed by the cursor key or the Tab key. In this case, the CPU 11 reads out the uneditability setting information 160 and acquires uneditability setting values (“FALSE” and “TRUE”) related to the cell (1, 2). The uneditability setting values related to the cell (1, 2) include an uneditability setting value related to a row (a setting value of a first row), an uneditability setting value related to a column (a setting value of a second column), and an uneditability setting value related to the cell (1, 2) itself. “FALSE” as the setting value of the first row, “TRUE” as the setting value of the second column (“BBB_BB_BB”), and “FALSE” as the setting value of the cell (1, 2) itself are acquired from the uneditability setting information 160 shown in FIG. 3.

The CPU 11 determines on the basis of the setting information acquired in ACT 6 whether the cell set as the candidate of the moving destination is editable (Act 7). In the example in which the shift to the cell (1, 2) is instructed, since the setting value of the second column (“BBB_BB_BB”) is “TRUE” and uneditability is set, the CPU 11 determines that the cell is uneditable. In this way, if any one of the uneditability setting values related to the row, the column, and the cell itself is set as uneditable, the CPU 11 may determine that the editing of the cell is impossible. If all the uneditability setting values related to the row, the column, and the cell itself are set as editable, the CPU 11 may determine that the editing of the cell is possible.

If the cell set as the candidate of the moving destination is determined as editable (Yes in Act 7), the CPU 11 serving as a cursor moving unit moves the cursor to the cell set as the candidate of the moving destination (Act 8). If it is determined that the cell set as the candidate of the moving destination is uneditable (No in Act 7), the CPU 11 performs increment processing for incrementing the cell set as the candidate of the moving destination to the next cell corresponding to operation (Act 9). Specifically, if the operation for shifting a cell is the pressing operation of the cursor key, a cell adjacent to the cell set as the candidate of the moving destination at the present point in a direction designated by the cursor key is set as the next candidate. If the operation for shifting a cell is operation by the Tab key, a cell set in advance (e.g., a cell on the right of the cell set as the candidate of the moving destination at the present point) is set as the next candidate.

According to the processing explained above, in the information processing apparatus 1, during editing of the table data 150 corresponding an operation input from the user, when the operation for shifting the editing target cell is received and the cursor is moved among the cells, the cursor is moved to an editable cell skipping an uneditable cell. Therefore, in the information processing apparatus 1, when the cursor is moved among the cells, the cursor is not moved to an uneditable cell. In the information processing apparatus 1, it is unnecessary to perform the operation for moving the cursor to an editable cell that is performed if the cursor is moved to an uneditable cell. Therefore, it is possible to improve operability.

The user master data 151, the commodity master data 152, and the like utilized in a store such as a restaurant or a supermarket include items set as uneditable and items to be edited according to a present situation such as a job situation. For example, in the user master data 151, a user name and the like are uneditable items and a user telephone number and the like are items to be edited. In the commodity master data 152, a commodity name and the like are uneditable items and a sales price and the like are items to be edited. The information processing apparatus 1 can improve, according to the present situation such as the job situation, operability in performing the editing of the user master data 151 and the commodity master data 152.

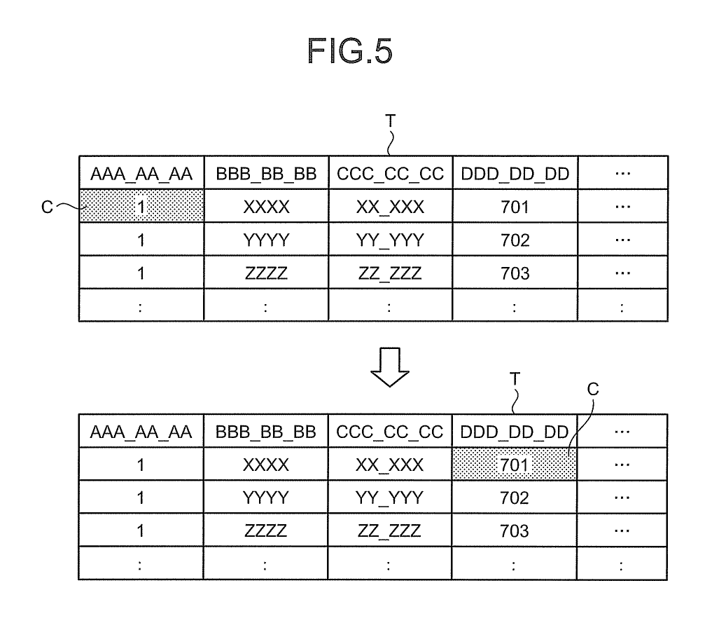

FIG. 5 is a diagram of an example of movement of a cursor C. As shown in FIG. 5, on an editing screen T for the table data 150 displayed on the display unit 141 or the like, it is assumed that, before operation for shifting a cell is received, the cell (1, 1) is an editing target and the cursor C is present on the cell (1, 1). It is assumed that the uneditability setting information 160 concerning a table displayed on the editing screen T is as shown in FIG. 3 and a setting value of a cell (1, 4) itself is “FALSE”.

At this point, if operation for shifting the editing target cell in the right direction is received, first, the cell (1, 2) is set as a candidate of a moving destination. However, since the setting value of the second column (“BBB_BB_BB”) concerning the cell (1, 2) is “TRUE” and uneditability is set in the cell (1, 2), a cell (1, 3) corresponding to the operation in the right direction is set as the next candidate, similarly to the cell (1, 2), since the setting value of the third column (“CCC_CC_CC”) concerning the cell (1, 3) is also “TRUE” and uneditability is set in the cell (1, 3), the cell (1, 4) corresponding to the operation in the right direction is set as the next candidate. Since the setting value of the fourth column (“DDD_DD_DD”) concerning the cell (1, 4) is “FALSE” and setting values of the first row and the cell (1, 4) itself are also “FALSE”, the cell (1, 4) is an editable cell. Therefore, the cursor C is moved to the cell (1, 4).

As explained above, the information processing apparatus 1 determines whether a cell set as a candidate of a moving destination corresponding to operation by the user is uneditable. If the information processing apparatus 1 determines that the cell is uneditable, the information processing apparatus 1 repeatedly sets the next cell corresponding to operation by the user as a candidate. Consequently, when operation for shifting an editing target cell is received, shift to an editable cell corresponding to the operation is performed.

The computer program executed in the information processing apparatus 1 according to this embodiment is provided while being incorporated in a ROM or the like in advance. The computer program executed in the information processing apparatus 1 according to this embodiment may be configured to be provided while being recorded on a computer-readable recording medium such as a CD-ROM, a flexible disk (FD), a CD-R, or a DVD (Digital Versatile Disk) as a file of an installable format or an executable format.

The computer program executed in the information processing apparatus 1 according to this embodiment may be configured to be provided while being stored on a computer connected to a network such as the Internet and downloaded through the network. The computer program executed in the information processing apparatus 1 according to this embodiment may be configured to be provided or distributed through the network such as the Internet.

The computer program executed in the information processing apparatus 1 according to this embodiment has a module configuration including the units (the display unit and the cursor moving unit). As actual hardware, the CPU 11 (a processor) reads out the computer program from the ROM 12 and executes the computer program, whereby the units are loaded to the RAM 13 and the display unit and the cursor moving unit are generated on the RAM 13.

What is claimed is:

1. An information processing apparatus comprising:
an operation unit configured to receive operation by a user;
a display unit configured to display an editing screen including plural cells included in table data and a cursor indicating a place where editing corresponding to the operation is executed; and
a cursor moving unit configured to move, if cursor moving operation for moving the cursor among the cells is received, the cursor to an editable cell on the basis of setting information indicating possibility of editing set in advance for each element of at least one of a row, a column, and a cell of a table including the plural cells.

2. The apparatus according to claim 1, wherein the cursor moving unit sets a cell corresponding to the cursor moving operation as a candidate of a moving destination with respect to an editing target cell on which the cursor is present before the cursor moving operation is received, refers to the setting information related to the cell set as the candidate, and, if the cell set as the candidate is editable, moves the cursor to the cell.

3. The apparatus according to claim 2, wherein the cursor moving unit refers to the setting information related to the cell set as the candidate and, if the cell set as the candidate is uneditable, sets a next cell corresponding to the cursor moving operation of the cell set as the candidate as a candidate of a moving destination.

4. The apparatus according to claim 3, wherein the cursor moving unit sets the cell set as the candidate as uneditable if any one of pieces of setting information of a row, a column, and a cell of the table related to the cell set as the candidate is uneditable.

5. The apparatus according to claim 1, wherein the cursor moving operation is operation for indicating a moving direction of the cursor received by a cursor key or a tab key of the operation unit.

6. A control method for an information processing apparatus including an operation unit configured to receive operation by a user and a display unit, the method comprising:
displaying an editing screen including plural cells included in table data and a cursor indicating a place where editing corresponding to the operation is executed; and
moving, if cursor moving operation for moving the cursor among the cells is received, the cursor to an editable cell on the basis of setting information indicating possibility of editing set in advance for each element of at least one of a row, a column, and a cell of a table including the plural cells.

7. The method according to claim 6, wherein the moving the cursor includes setting a cell corresponding to the cursor moving operation as a candidate of a moving destination with respect to an editing target cell on which the cursor is present before the cursor moving operation is received, referring to the setting information related to the cell set as the candidate, and, if the cell set as the candidate is editable, moving the cursor to the cell.

8. The method according to claim 7, wherein the moving the cursor includes referring to the setting information related to the cell set as the candidate and, if the cell set as the candidate is uneditable, setting a next cell corresponding to the cursor moving operation of the cell set as the candidate as a candidate of a moving destination.

9. The method according to claim 8, wherein the moving the cursor includes setting the cell set as the candidate as uneditable if any one of pieces of setting information of a row, a column, and a cell of the table related to the cell set as the candidate is uneditable.

10. The method according to claim 5, wherein the cursor moving operation is operation for indicating a moving direction of the cursor received by a cursor key or a tab key of the operation unit.
